(19) United States
(12) Patent Application Publication
(10) Pub. No.: US 2006/0107870 A1
(43) Pub. Date: May 25, 2006

(54) Ski wax formulation

(76) Inventor: Drexell Barnes, (US)

Correspondence Address: GLENN C. BROWN, PC, 777 NW WALL STREET, SUITE 308, BEND, OR, 97701, US

(21) Appl. No.: 11/284,602

(22) Filed: Nov. 21, 2005

Related U.S. Application Data
(60) Provisional application No. 60/629,839, filed on Nov. 19, 2004.

(51) Int. Cl. C08L 91/06

(52) U.S. Cl. 106/270; 106/10; 106/271; 106/272

(57) ABSTRACT

A wax formulation formulated from natural waxes and including soy wax as a primary component in combination with other naturally occurring waxes and oils. Colorants may be included, as well as traction enhancing components such as graphite.

### RELATED APPLICATIONS

This application claims priority to U.S. Ser. No. 60/629,839, filed Nov. 19, 2004.

### BACKGROUND

This invention relates to ski waxes, and in particular to a novel formulation for ski waxes that are appropriate for use on cross-country skis and downhill skis.

Cross country skiing traces its roots back about two thousand years the part of the world that is now known Finland, Sweden and Norway. The sport originated as a way for hunters to travel to hunt and fish during the winter, and was later used by the military. Skiing became a sport in North America during the 1800's. Since then the sport of downhill skiing has surpassed cross country skiing in popularity.

There are three primary forms of cross country skiing, classic, telemark and skate styles of skiing. In each case a glide wax is applied to the bottom of the skis. In telemark and skate skiing glide wax is applied along the entire base of the ski. In classic cross country skiing glide wax is applied to the front and rear portions of the ski, while a “kick” wax is applied to the center portion. Kick wax is applied in order to cause the center portion of the ski to grip the snow as the skier transfers their body weight to the ski and kicks toward the rear to propel themselves forward.

As skiing developed, treatments or “dopes” were developed for the bottoms of their skis to make them go faster and to grip the snow to permit the skier to propel themselves forward and to keep from backsliding when going uphill. Early formulations contained ingredients such as bear fat, spruce sap, honey and lamp oil. In the early 1900's dopes evolved into waxes that were formulated using paraffins and other hydrocarbons. It was at this point that waxes were first offered in different formulations to perform best in different snow conditions. As chemical technology evolved during the 1900's, ski waxes came to include additives such as graphite and fluorocarbons.

Modern skis are manufactured with polyethylene bases, which are processed by sintering to provide a sponge-like surface. Wax is applied in liquid form and permeates and fills the sponge-like surface. Most of the wax is removed by scraping and brushing, leaving only raised portions of the ski surface and wax in contact with the snow.

Most modern ski waxes for polyethylene surfaces are formulated primarily from paraffins, microcrystalline waxes and synthetic waxes. Paraffins are soft, candle-like waxes containing 25-30 carbon atoms. Paraffins have a low coefficient of friction and promote gliding of the ski over the snow. Microcrystalline waxes are branched hydrocarbons having 25-50 carbon atoms, and have a higher coefficient of friction. They are more durable than paraffins and do not wear off of the ski as easily. Synthetic waxes are branched hydrocarbons that typically contain 50-60 carbon atoms. These waxes are also more durable and more wear resistant than paraffins. The ratios of these components are varied to adapt the wax to various snow conditions.

In more recent years, fluorocarbons have been added to wax formulations to promote glide in wet snow conditions and in dirty snow. The primary types of fluorocarbons used in ski waxes are PTFE (marketed as Teflon by DuPont), perfluorocarbons, and a hybrid hydrocarbon-fluorocarbon. Waxes contain from about 1-16% fluorocarbons.

In recent years there has been growing concern about the amounts of hydrocarbons and fluorocarbons inserted into the environment by skiers. As the wax is worn from the base it is deposited on the snow, and then into the underlying soil when the snow melts. There is currently no alternative to hydrocarbon/fluorocarbon based formulations.

### DETAILED DESCRIPTION OF PREFERRED EMBODIMENTS

The present invention provides an alternative to the formulations of the prior art, and one which includes a variety of formulations in which do not rely on synthetic waxes for the desired properties, but rather include soy wax as a base material one or more other naturally-derived waxes in combination with the soy wax base to provide the desired properties.

A ski wax formulation according to one preferred embodiment of the invention comprises about 50% soy wax, 15% bees wax, 15% carnuba and 20% candellila wax. A second preferred embodiment of the invention comprises about 52% soy wax, 14% bees wax, 14% carnuba and 20% candellila wax.

In other embodiments, any of the ingredients could be varied in relative amounts, or could be combined with other naturally derived waxes, such as almond oil, apricot kernel oil, avocado oil, carrot oil, cedarwood oil, citronella oil, clove oil, coconut oil, corn oil, fir needle oil, grapefruit oil, kukui nut oil, lavender oil, limon oil, macadamia oil, mushroom oil, olive oil, orange blossom oil, palm kernel oil, patchouli oil, pine oil, rice bran oil, sage oil, sesame oil, soybean oil, bayberry wax, japan wax, jasmine wax, jojoba wax, lanolin wax, mimosa wax, orange peel wax, palm wax, and rice bran wax, tall oil rosin ester, xanthan gum, stearic acid.

In other embodiments a wax according to the invention can also comprise a colorant for either decorative purposes, or to signify particular formulations or temperature range suitability for a particular formulation.

In other embodiments, a wax according to the invention includes a small amount of graphite which is provided to enhance the performance of the wax by reducing the static build up in the wax. In preferred embodiments graphite comprises about 0.1% for an all-temperature wax, and about 0.4% for use in a cold temperature wax.

In other preferred embodiments of the invention, the addition of combination of soy wax, beeswax, carnuba wax, candililla wax and palm wax has been discovered to be a particularly desirable combination. This combination of ingredients can be varied to tailor the wax to particular temperature ranges. For example, one preferred formulation for a soft, warm temperature wax comprises about 85% soy wax, 10% bees wax, and 5% palm wax. A colorant, if included, comprises about 0.05% or less. Another preferred formulation for a medium hardness, all temperature wax comprises about 54.9% soy wax, 8% bees wax, 8% carnuba wax, 14% candelilla wax, 15% palm wax, and 0.1% graphite. Another preferred formulation for a relatively hard cold temperature wax comprises about 45.4% soy wax, 12.2% bees wax, 24.5% carnuba wax, 17.5% candelilla wax, and 0.1% graphite. A colorant, if included, comprises about 0.05% or less.

Those of skill in the art will appreciate that the embodiments described can be varied in formulation without departing from the scope of the invention.

1. A ski wax formulation comprising soy wax in combination with one or more other natural waxes.

2. A ski wax formulation according to claim 1 comprising between about 45% and 85% soy wax.

3. A ski wax formulation according to claim 2 comprising between about 10% and 20% bees wax.

4. A ski wax formulation according to claim 2 comprising between about 10% and 20% carnuba wax.

5. A ski wax formulation according to claim 2 comprising between about 15% and 25% candellila wax.

6. A ski wax formulation according to claim 1 comprising about 50% soy wax, 15% bees wax, 15% carnuba and 20% candellila wax.

7. A ski wax formulation according to claim 1 comprising about 52% soy wax, 14% bees wax, 14% carnuba and 20% candellila wax.

8. A ski wax formulation according to claim 1 wherein the one or more other natural waxes are selected from the group consisting of bayberry wax, japan wax, jasmine wax, jojoba wax, lanolin wax, mimosa wax, orange peel wax, palm wax, and rice bran wax.

9. A ski wax formulation according to claim 1 comprising soy wax in combination with one or more natural oils selected from the group consisting of almond oil, apricot kernel oil, avocado oil, carrot oil, cedarwood oil, citronella oil, clove oil, coconut oil, corn oil, fir needle oil, grapefruit oil, kukui nut oil, lavender oil, limon oil, macadamia oil, mushroom oil, olive oil, orange blossom oil, palm kernel oil, patchouli oil, pine oil, rice bran oil, sage oil, sesame oil, and soybean oil.

10. A ski wax formulation according to claim 1 comprising soy wax in combination with tall oil rosin ester.

11. A ski wax formulation according to claim 1 comprising soy wax in combination with xanthan gum.

12. A ski wax formulation according to claim 1 comprising soy wax in combination with stearic acid.

13. A ski wax formulation according to claim 1 comprising soy wax in combination with a colorant.

14. A ski wax formulation according to claim 1 comprising soy wax in combination with a traction-enhancing component.

15. A ski wax formulation according to claim 1 comprising about 85% soy wax, 10% bees wax, and 5% palm wax.

16. A ski wax formulation according to claim 1 comprising about 54.9% soy wax, 8% bees wax, 8% carnuba wax, 14% candelilla wax, 15% palm wax, and 0.1% graphite.

17. A ski wax formulation according to claim 1 comprising about 45.4% soy wax, 12.2% bees wax, 24.5% carnuba wax, 17.5% candelilla wax, and 0.1% graphite.

18. A ski wax formulation according to claim 14 comprising soy wax in combination with graphite.
